(19) United States
(12) Patent Application Publication
(10) Pub. No.: US 2005/0203790 A1
(43) Pub. Date: Sep. 15, 2005

(54) Computerized, rule-based, store-specific retail merchandising

(76) Inventor: Robert M. Cohen, Redwood City, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/064,720

(22) Filed: Feb. 23, 2005

Related U.S. Application Data
(60) Provisional application No. 60/552,032, filed on Mar. 9, 2004.

(51) Int. Cl. G06F 17/60

(52) U.S. Cl. 705/9

(57) ABSTRACT

Customized plans for product allocation and placement in a retail outlet are automatically generated using simple rule-based instructions. Descriptions of the business rules and information regarding specific stores is input to the automated system to generate customized planograms for any particular store. Implementations of an Artificial Intelligence engine provide an automated conversion of business rules to mathematical representations to select the optimal product for placement at any given shelf location.

### CROSS-REFERENCE TO RELATED APPLICATIONS

This application claims priority from U.S. Provisional Application Ser. No. 60/552,032 titled “Computerized, Rule-Based, Store-Specific Retail Merchandising” and filed on Mar. 9, 2004 by Robert M. Cohen, which is incorporated herein by reference in its entirety.

### FIELD OF THE INVENTION

The present invention relates generally to the field of retail merchandising, and more specifically to the automated production of store-specific product allocation and placement using easily modifiable business rules.

### BACKGROUND OF THE INVENTION

Conventional space and category management and planning systems are used to specify the location and placement of products within a retail space or store, such as, for example, a supermarket, a consumer electronic retail store, or the like. Product location in the store is a major factor in driving sales. The location of a product with respect to the display fixtures used in the store, i.e. top, bottom, end of shelf, or the like, can have a major bearing on a product's commercial success. Another important aspect of space management is the consistency in “look and feel” that store chains offer to their customers to provide a level of comfort and familiarity with product location regardless of the actual store visited. This allows a customer to know what to expect in terms of merchandise selection, price-point, and presentation, regardless of the actual store visited.

For this reason, a common practice in the retail merchandising industry is the specification of the location of products in a detailed diagram known as a planogram (“POG”). A planogram is a detailed diagram or picture that shows how products should be placed on retail shelves and displays. Planograms are the blueprints that visually communicate how merchandise and props physically fit onto a store fixture, window, floor plan, or the like to allow for proper visibility and price point options. Using a planogram, a multi-store retailer can visually communicate to each store the required product placement so that all the stores provide a uniform “look and feel.” With respect to this description reference is made to “stores” as a general descriptive term that includes any space for visually displaying of products to consumers (including business consumers), for example, including without limitation, conventional stores, warehouses, boutiques, retail centers, supermarkets, electronic or virtual stores, and the like.

In order to compose a good planogram, a market analyst (or planogrammer) typically analyzes market data such as space utilization, financial data, customer buying patterns, store flow, customer convenience, and the like. Based on the market data, the planogrammer can compose a planogram and provide reports, permitting retailers and manufacturers to effectively plan and set-up their products so as to maximize efficiency of retail space and sales.

For the last few decades, a select few graphics-based computer programs have dominated the market for retail product allocation and placement systems. These programs allow a trained analyst to draw the graphical planograms of how products in a store ought to be arranged. These conventional graphics-based computer programs provide for the analyst a graphical interface and a set of line graphic or drag-and-drop pictorial tools in order to develop these planograms.

The analyst follows a fairly standardized procedure: He receives verbal instructions from his management on which products should generally be included in the planogram and how they should be displayed. The analyst then goes off and gets the necessary product data, such as package dimensions and sales history, and then drags and drops images of those products about the screen using a mouse or other pointing device.

Once the analyst has his picture he then presents it to his management for approval and/or modification, and after that reproduces it for distribution. This may or may not be the end of the process, depending on whether a store has serious issues with its picture. If it does, there is another process invoked in order to rectify those issues. This process usually consists of a further series of phone calls, meetings and revisions.

A major drawback of this process is that it is slow and time consuming. With the phone calls, the meetings, the revisions and the approvals, some changes can take as much as five weeks to implement. The process is slow because at each step an otherwise-understood, codified business process must go through a series of human interventions and interpretations.

This slow process is even more detrimental to the merchandising process with the new trends in regional or even store-based planification. It is considered axiomatic in the retail sector that if product selection and placement could be managed on a store-by-store basis, then chain-wide sales and profitability would be maximized. Recent efforts in the both the supply and the demand chain emphasize store-specificity.

However, as mentioned above, a necessary constraint on the retail process is that all stores within a given chain must have a similar look-and-feel. This allows a consumer to walk into any store within the chain and know what to expect in terms of merchandise selection, price-point and presentation. Typically, the chain's merchandising staff manages this part of the retail process. The merchandising staff is responsible for planning the product assortment and display.

The tools currently available to the merchandising staff are typically based on the conventional, 20-year-old, slow model described above. This model is too slow and cumbersome to generate true store-specific results capable of adaptation to store-specific needs. In general, this approach suffers from several crippling flaws. For example, it is slow and it is not “transparent” enough for users to gain an understanding of the operation and to allow easy modifications as reaction to market changes. Further, the current tools permit a skilled user to create only about one result per hour, and that one is usually based only on placement and adjacency issues, not financial optimizations. In addition, because the current process is so dependent on unwritten human decisions, there is no way for a third party to look at the results and easily understand what business process created them.

These flaws prevent the production of true store-level solutions. The state of the art today is that a solution or planogram can only apply to a cluster of similar stores, usually 30-50. An individual store within that cluster that has unique demographic or physical requirements must make manual modifications to the “recommended” planogram. At that point the system starts to break down as the stores are usually not equipped to make those decisions based on historical data, forecasted sales, pricing policy and look-and-feel requirements.

Therefore, there is a need for (1) an automated system to provide a fast planogramming tool (2) that is easily adaptable for the needs of individual stores, and (3) that integrates human business rules in an easily modifiable way, in order to efficiently produce true store-level merchandising planning results.

### SUMMARY OF THE INVENTION

The present invention includes systems, methods, and computer readable media for retail merchandising wherein mathematically codified business rules are applied to retail business data to automatically generate product placement information.

In one embodiment, a computer based merchandising method for generating retail space planograms includes receiving a job data set. The job data set includes business rules for associating products with fixture locations. The method includes generating logic functions associated with the business rules based on descriptions of the business rules. The method also includes generating a value with respect to a fixture location for various products based on the logic functions. Then, a product is associated with the fixture location by selecting the product through a comparison of the generated values. The association of the product-fixture location association is then provided as a result.

In one embodiment, the job data set includes store-specific data that is used to generate store-specific results. Similarly, business rules can be based on the store-specific data to generate customized store-specific results, for example, private label placements, demographic group specific results, and the like.

According to another aspect of the invention, one embodiment of a computer based merchandising system for generating retail space planograms includes a database and a merchandising module. The database is intended for storing information components of the system, including a set of store-specific information components. The merchandising module is coupled to the database module for receiving business rules. The merchandising module is also for composing logic functions associated with the business rules for implementing the business rules in generating a planogram.

Alternative embodiments of the system include other modules, such as a stores module for interfacing with stores, a management module for review and approval of the planograms, and an administration module for interfacing with other retailing computer data systems.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a block diagram depicting functional block elements of one embodiment of a merchandising system.

FIG. 2 is a flow chart of one embodiment of a merchandising process.

FIG. 3 is a functional flow chart for one embodiment of an AI engine's merchandising method.

FIG. 4A is a sample plot of a set of 3-value membership functions of a profitability rule for implementation into a fuzzy logic algorithm.

FIG. 4B is a sample plot of a set of 5-value rectilinear membership functions of a profitability rule for implementation into a fuzzy logic algorithm.

FIG. 4C is a graphic representation of a truth-value correspondence between a set of propositions implemented using a set of simple membership functions for a sequence of 5 alphabetic values based on a fuzzy logic algorithm.

FIG. 5 is a flow chart for one embodiment of a category-within-aisle optimization method.

FIG. 6 is a flow chart for one embodiment of a private label analysis method.

### DETAILED DESCRIPTION OF THE INVENTION

The figures (“FIG.”) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

### System Overview

The process of merchandising is inter-disciplinary. While the merchandisers produce the actual output (planograms), they use input prepared by other departments within a retailer. For example, they may use product data from the IT department, pricing data and forecast numbers from other groups. The primary users of the merchandising output are the stores. Secondarily, however, upper management has an interest in various chain-wide aggregated numbers produced by merchandising. One aspect of a system according to one embodiment of the present invention involves the structuring around this type of inter-discipline interaction.

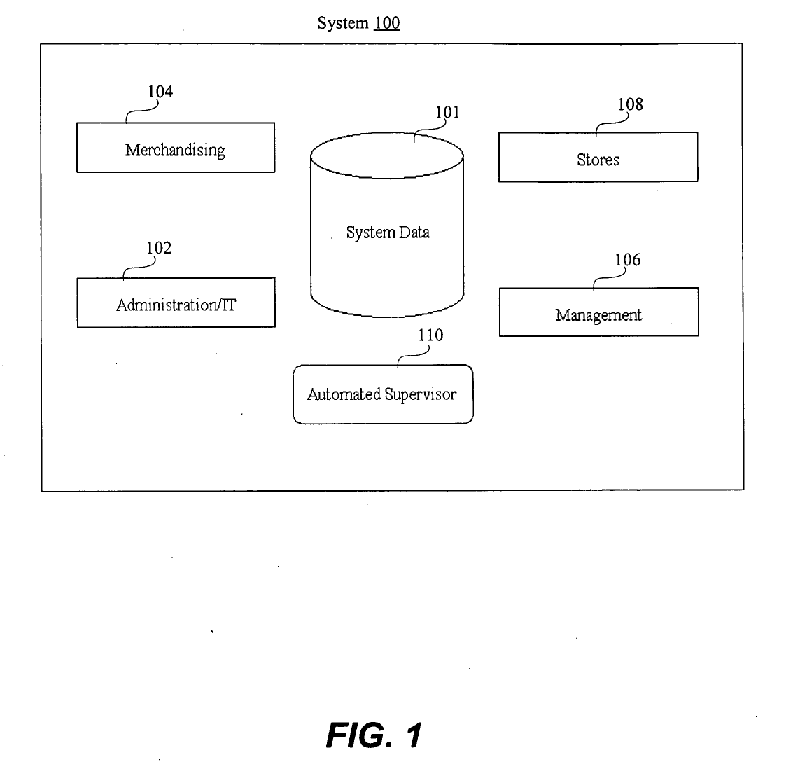

Now referring to FIG. 1, a block diagram depicting functional block elements of one embodiment of a merchandising system, System 100, is shown. In one embodiment, these functional block elements are implemented by conventionally programming networked general-purpose computers to function as described below. System 100 includes the System Data 101 large-scale database. System Data 101 interacts with a series of modules that are appropriate to user communities within a retailer enterprise. The System Data 101 includes several data components. These data components will vary in different implementations depending on the complexity and the features desired for the particular implementation. The data components include a System Dictionary, User Validation, Store Description, Product Information, Store-Specific Sales Information, Merchandising Projects, Store-Specific Product Information, and the like.

The System Dictionary is where all textual phrases in the System 100 reside. Store Descriptions typically include identification information and physical characteristics of the stores. Product Information is the product descriptive profile that is typically kept at a corporate-wide level to identify and describe every product sold. Store-Specific Sales Information include historical data and forecasted data for each store in a chain. Merchandising Projects can include the system's business rules to be used as a source for product placement guidelines. Store-Specific Product Information more specifically details quantity and location of each product in each place in each store. In one embodiment, a correlation between Product Information and this data component is included.

Elements of the System Data 101 database are collected or entered into the database either manually or automatically. Some of the data is regularly delivered in an automated fashion from the retailer's IT department. Data is also regularly sent back to the IT department. For smaller operations, a single store may use the same system and have a more manual data entry operation since the volume of data is likely more manageable.

System 100 also includes the Administration/IT module 102, which is responsible for maintaining and updating the System Data 101. The Administration/IT module 102 provides manual access to each and every piece of information inside System Data 101. This module also provides for the control and validation of the automated data transfer to and from the IT department.

The Merchandising module 104 of System 100 is where the system's business rules are entered. The user, typically a merchandising analyst, enters descriptions of the business rules into the system in order to describe the desired results. The descriptions of the business rules may be textual, pictorial, spoken, or the like. It should be noted that a system according to this embodiment is not limited to the English language. In one embodiment, the System 100 provides a merchandising-oriented vocabulary for the user to select from when composing the different rules that he wishes to employ. The analysts construct their own rules or alternatively, in one embodiment, at least some of the rules are pre-built by the system's administration staff.

According to one embodiment, the Merchandising module 104 is structured around the concept of a “Project”. A Project in this context tracks very closely with a merchandising project in the real world. It models such attributes as product categories, dates, revisions and signatory authority. A Project may include a set of Mastergrams describing sets of business rules associated with a particular set or category of products. A Mastergram of a particular category of products is used to determine the placement of products of that category within a shelf. Generally, the Mastergrams are modules applicable to sets or categories of products for multiple locations. For example, multiple Mastergrams can be used to place products in a particular aisle of stores associated with a supermarket chain. A chain of stores may use Mastergrams for each category of products they carry. In one embodiment, Mastergrams may be modified with store specific information to further customize product placement to the store-specific level.

To compose the Project or Mastergrams within it, the user enters his merchandising “program” into his project and has the option of testing it immediately against individual stores within the system. At the point that the analyst tests his program, the system converts the human-readable rules into a machine-sensible form and applies those rules to the data for the selected store. The results are displayed almost immediately in the form of both pictures and reports. The analyst uses System 100 to repeat this testing process against any of the stores at his disposal.

Certain stores in a chain may require some modification to the analyst's program in order to more accurately reflect their characteristics. An attribute of the System 100 is that it enables the analyst to add store-specific rules alongside the more general chain-wide rules. The effect of the store-specific rules is to emphasize that store's unique traits, but still within the context of the more general rules.

In one embodiment, when the user, e.g., analyst, is satisfied that a program correctly describes a set of requirements, the user electronically signals management that the Project is ready to be authorized. Management, using the Management module 106 of System 100, electronically authorizes the Project. Once authorized, the Project is made available to the Stores via the automated Store Module 108 and to the Automated Supervisor Module 110.

The Stores are primarily interested in the pictures of their product layouts, along with textual descriptions of those layouts. The Stores Module 108 allows a remote store user to retrieve the store's planograms for a particular point in time. The System 100 provides an interface to retrieve planograms locally and by remote-access. For some retailers, this feature of System 100 allows for a world-wide, round the clock operation with distributed functions in different parts of the world.

Another aspect according to one embodiment, is the ability for the stores to enter some of their own data and requirements. Just as the merchandising analysts are able to enter store-specific program rules, so too can the stores. In one embodiment, this feature is provided under an electronic “lock-and-key” system that restricts the rule editing functions. The “lock-and-key” system allows editing function restrictions for enterprises who do not wish to give their stores the ability to freely modify program rules.

With the same type of restricted, lock-and-key system arrangement, System 100 provides editing functions for store specific physical descriptions. A major problem in the merchandising process is that the headquarters, where all of the planning takes place, doesn't have the latest store physical layout or configuration. The headquarters analyst is typically unaware of a store's latest changes to its physical shelf sizes, pillars, obstructions and other issues that might interfere with the analyst's plan.

Currently, these physical store anomalies must be communicated from the stores back to the headquarters in a circuitous, manual and time-consuming fashion. According to one embodiment of the System 100, a remote user has limited editing access to the System Data 101 to modify a particular store configuration directly. The System 100 provides a set of simple tools for store-based users to describe the current physical layout of their particular store. Accordingly, shelf sizes, traffic patterns, obstructions, and other host of store-specific characteristics can be instantaneously communicated to the central System Data 101.

Another aspect according to one embodiment of the System 100, includes the remote store user ability to test the effects of his input before it becomes permanently committed into any Project. Just as the merchandising analyst makes non-binding changes to his program and sees the immediate effect of those changes, so too a store user makes non-binding changes to his physical description and immediately sees the effect of those changes. The store user has a test facility much the same as that of the merchandising analyst.

As mentioned above, management has an overwhelming interest in getting information about all of the products in all of the stores. There is a continual need to see output data (the store-specific product data) massaged and aggregated into management reports. That is the function of the Management module 106. The Management module 106 provides a query and report facility into the System Data 101. The Management module 106 is able to “slice” and “dice” the data in a number of ways to create customized or standardized reports.

In addition, the Automated Supervisor module 110 is functionally responsible for the database's state, that is, the Automated Supervisor module 110 assures that the System Data 101 contains current and accurate data. According to one embodiment of the present invention, the Automated Supervisor module 110 operates unattended in a “background” mode constantly looking for Projects that have been approved but not yet executed. Among other things, the Automated Supervisor module 110 is responsible for the actual population of the Store-Specific Product data.

### Planogram Production

Another aspect according to one embodiment of the System 100 is the production of planograms from human-readable business rules. The System 100 uses an artificial intelligence (“AI”) engine to make selection and placement decisions.

In one embodiment of System 100, the AI engine is based on the Fuzzy Logic (“FL”) discipline. However, other embodiments may slot in other engine types or, in fact, run several differing AI engines concurrently. In this case, a System 100 according to such embodiment produces a series of directed “solutions” from the various engines and compare the results of those solutions. The solution best satisfying the business rules is selected and presented to the user.

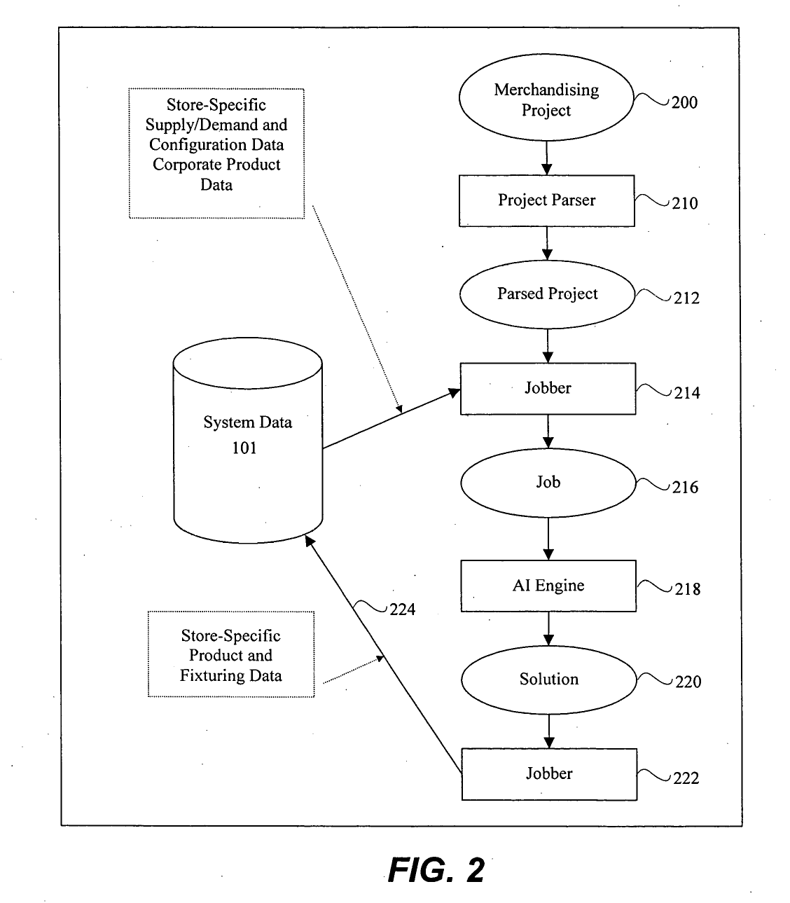

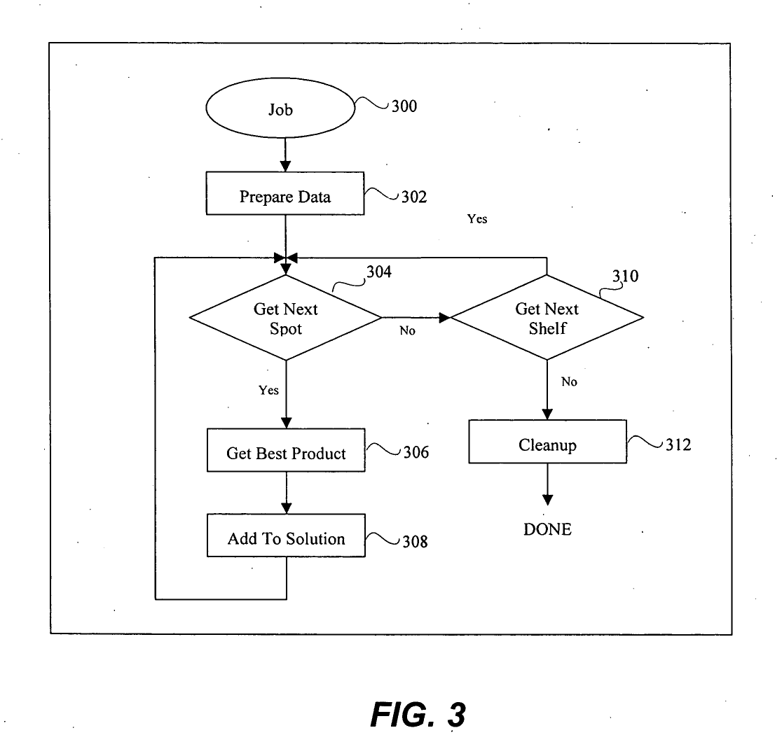

Now referring to FIG. 2, a flow chart of one embodiment of a merchandising process is shown. In one embodiment, an AI engine, such as for example the AI engine shown in FIG. 3, functionally operates the process. As shown in FIG. 2, the business rules are received 200 as plain text embedded within a merchandising Project. A Project Parser module breaks down 210 the elements of the Project into rationalized software objects and constructs. The output 212 of the Program Parser is a “Parsed Project”. The output includes, for example, the dates that the planogram will span, the affected portions of the store, the store identification itself, and the like. The output also includes the business rules in a form that can be understood by the AI engine.

The Parsed Project is still fairly generic at this point and is thus handed off to a “Jobber” module whose task it is to load up 214 the data for a particular store. The Jobber takes Parsed Projects, packages in store-specific data and produces 216 “Jobs” from them. A Job typically contains all the data and rules necessary to produce a result for a single store. The Jobber then instantiates 218 the AI engine and instructs it to process the Job.

The output 220 of the AI engine is a “Solution.” A Solution contains a description of the output. This generally includes store-specific product information, quantity and location, store-specific fixturing information, and other store-specific information. Another aspect according to one embodiment of System 100, is the capability of automatically selecting and positioning the required shelving on a store-specific basis, using the business rules of the Project and the store-specific data.

The AI engine gives 222 the finished Solution back to the Jobber, which wraps up the process. The Jobber is responsible for taking the data within the Solution and plugging it back 224 into the appropriate spots within the System Data 101. At this point, all intermediate elements of the process are collected and destroyed. Some elements left are the original Merchandising Project and the data that the Jobber extracted from the Solution and placed in the System Data 101 table.

FIG. 3 shows a functional flow chart for one embodiment of an AI engine's merchandising method. The AI engine accepts 300 a Job from the Jobber at the start of its lifecycle. The Job contains everything needed to produce a Solution for a single store. It contains business rules, corporate-level product data, store-specific historical and forecast data, store-specific fixture information, dates, and the like.

The AI engine starts by preparing 302 the data for processing. Then, it begins a cycle by selecting 304 the next available “Spot” in 3-space and asking the question “What's the best product to put here?” The term “best product” is determined by the business rules and can relate to almost any piece of information in the product record, the store record or the shelf record. The AI engine tries each product in the Spot and then selects 306 the “best” or optimal product based on the rules provided. This best product is then configured for the store and placed 308 in the Spot. The AI engine then moves on to the next Spot 304 and repeats the process.

When there is no more room on the current shelf, the AI engine runs out of Spots. The AI engine then asks the store to supply 310 another shelf and an appropriate starting Spot on it. If the store cannot supply another shelf, then the cycle is over and a final clean-up operation takes place 312. The clean-up operation is applied 312 to the solution in order to make minor modifications and adjustments to the final result. For instance, the extra, unassigned space on a shelf can be evenly redistributed to the residents thereon in order to give a more pleasing visual result.

### Algorithms

One aspect according to another embodiment is the implementation of the “Get Best Product” function in an AI engine. This step takes each and every product in the available assortment of products and tests its relative merit at a given location. According to one embodiment of the System 100, a Fuzzy Logic AI engine applies user's business rules for each product at each location to generate a final figure of merit (“FOM”) for each product in the system. The product with the highest FOM at the end of this step is put into the solution.

Using an AI engine to solve a business problem usually involves significant manipulation of the data by the user before useful output is available. In particular Fuzzy Logic typically requires the development of constructs called “membership functions” that are used to describe both the input and the output values of the system. Membership functions are difficult to create and often present critical roadblocks to a solution. One aspect according to one embodiment of the System 100 is the ability to automatically construct mathematically valid membership functions with limited or no user input.

Fuzzy Logic is a mathematical discipline used in solving a common class of complex, real-life problems. Fuzzy Logic is predicated on the observation that human beings, using imprecise natural language, are capable of solving complex problems rapidly to highly acceptable levels of accuracy. A corollary of Fuzzy Logic is that traditional Aristotelian logic, as typically used in computers, often fails at these exact same tasks. Examples of such tasks include tying shoelaces, parallel parking a car, washing clothes, and the like. These tasks are relatively easy for humans to accomplish, but relatively complex for computers to accomplish.

Fuzzy Logic solves problems by manipulating linguistic variables. A linguistic variable is a word that describes an input to the problem under discussion. In merchandising, for instance, “profitability” might be such a linguistic variable. A typical problem then is to select those products with the greatest profitability and a set of Fuzzy Logic rules appropriate to this problem space might be:
If profitability is high then rank is good
If profitability is average then rank is fair
If profitability is low then rank is poor

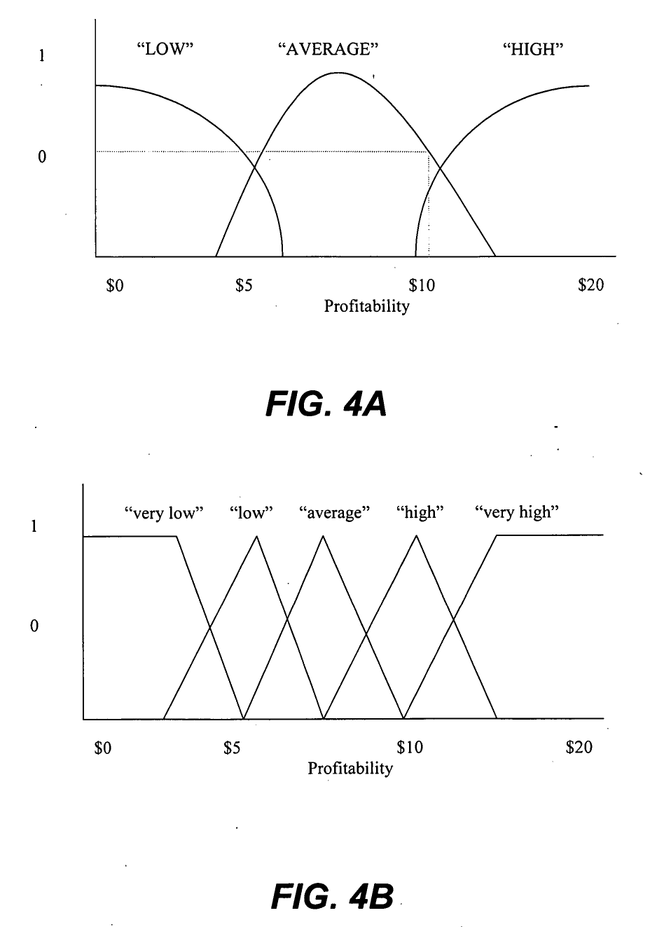

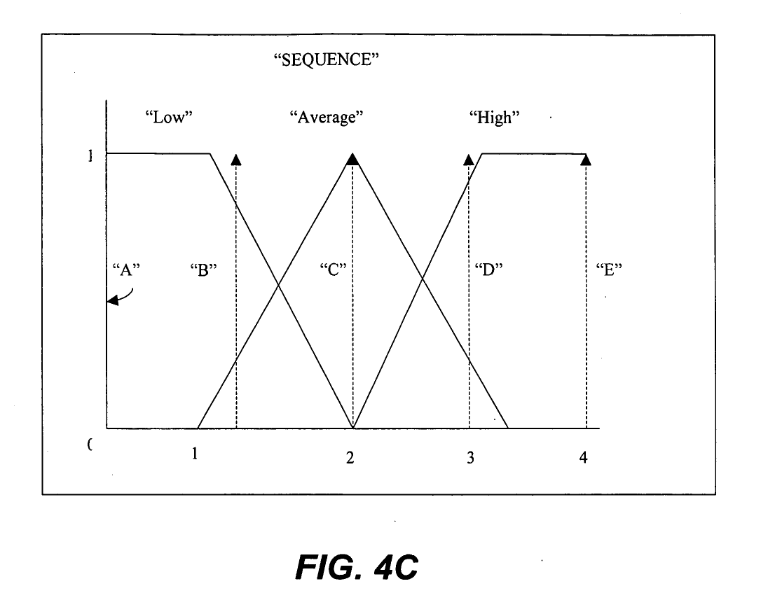

The terms “high,” “average,” and “low” are used to describe the profitability of the various products. Where Aristotelian logic would say that an item's profitability is either high or not high, Fuzzy Logic says that an item can have some degree of high profitability at the same time it has some degree of average profitability, and possibly, some degree of low profitability. This is illustrated in FIG. 4A, in which a sample plot of a set of 3-value membership functions of a profitability rule for implementation into a fuzzy logic algorithm is shown.

Referring to FIG. 4A, for this problem space “low profitability” is defined as the range from $0 per unit to about $6 per unit. “Average profitability” is defined as the range from about $4 to about $13, and “high profitability” is defined as the range upwards from $10.

It should be noted that a product with $10 profitability is considered “high profitability” to a low degree, about 30%. However, this same $10 profitability would be considered an “average profitability” to a degree of nearly 50%. Thus in a real world problem a single value might usefully be both average and high at the same time, although to varying degrees.

The curves in the diagram are called “membership functions” and are used by Fuzzy Logic processors to derive answers to real-world problems. Describing membership functions is one of the core requirements of the Fuzzy Logic process. The process of deriving these functions, however, can be quite tedious depending on the number of linguistic variables in the problem and the number of membership functions required for each linguistic variable.

### Alternative Algorithms

There is a large class of problems with sufficiently large item populations such that simple averages afford a good basis for developing membership functions. This technique has the following advantages:

It requires no user input beyond the problem's data points.

It is computationally fast.

For reasonably distributed problem populations, the results are highly acceptable.

Functions may be recomputed on the fly during the problem solution, as data points change.

A method according to one embodiment, includes the following steps:

Taking each linguistic variable in the problem set one at a time.

Computing the average value of the variable for the entire problem population.

Selecting the number of membership functions per variable.

Selecting the shape of the membership functions.

Placing the average value at the center of the membership function range.

Distributing the membership functions evenly about the average.

For example, a fuzzy logic algorithm is used to describe a thousand products in a store's inventory with an average profitability of $8 per unit using five-value levels. The profitability of the products is described with the following linguistic values: “very low”, “low”, “average”, “high” and “very high”. Simple rectilinear shapes for the membership functions are selected and calculated with known mathematical equations (e.g., y=mx+b). To illustrate this example, FIG. 4B shows a sample plot of a set of 5-value rectilinear membership functions of a profitability rule for implementation into a fuzzy logic algorithm.

There are, however, problems that require both numeric and alphabetic inputs. For example, one might want to ask the question: “How should I sequence a variety of grocery store products on a linear shelf in an order based on their manufacturer's name, and at the same time based on each product's profitability?” Solving this problem is not simply a matter of sorting each manufacturer's product according to its profitability and then arranging them sequentially. As a general rule, there will not be enough space to hold all of the available products and some of them will have to be discarded from the answer set.

A Fuzzy Logic algorithm is used to solve the problem by processing an exhaustive set of rules against the given data. In the above example there are three inputs, horizontal shelf position, alphabetic sequence position and profitability. For a 3-output system (“Good”, “Fair”, “Poor”), we can have up to 27 rules, for example:
(1) If X is Low and AlphaSequence is Low and Profitability is High then Rank is Good
(2) If X is Average and AlphaSequence is Low and Profitability is High then Rank is Fair
(3) If X is High and AlphaSequence is Low and Profitability is High then Rank is Poor
(4) If X is Low and Alpha Sequence is Average and Profitability is High then Rank is Fair
(5) If X is Average and AlphaSequence is Average and Profitability is High then Rank is Good
(6) If X is High and AlphaSequence is Average and Profitability is High then Rank is Fair
(7) If X is Low and AlphaSequence is High and Profitability is High then Rank is Poor
(8) If X is Average and AlphaSequence is High and Profitability is High then Rank is Fair
(9) If X is High and AlphaSequence is High and Profitability is High then Rank is Good
(10) If X is Low and AlphaSequence is Low and Profitability is Average then Rank is Fair
(11) If X is Average and AlphaSequence is Low and Profitability is Average then Rank is Poor
(12) If X is High and AlphaSequence is Low and Profitability is Average then Rank is Poor
(13) If X is Low and AlphaSequence is Average and Profitability is Average then Rank is Poor
(14) If X is Average and AlphaSequence is Average and Profitability is Average then Rank is Fair
(15) If X is High and AlphaSequence is Average and Profitability is Average then Rank is Poor

“X” and “Profitability” are both numeric inputs. X is the horizontal distance from the start of the shelf and profitability is self-explanatory. “AlphaSequence”, however, is not a simple number.

According to one embodiment, a procedure for converting alphabetic sequences into numeric inputs suitable for processing in a Fuzzy Logic engine of System 100 includes the following steps. One step to develop a set of Fuzzy Logic membership functions centered about one half of the number of elements in the sequence. Another step to use the ordinal placement of the test value within the sequence as the input to the membership functions.

FIG. 4C shows a graphic representation of a truth-value correspondence between a set of propositions implemented using a set of simple membership functions for a sequence of 5 alphabetic values based on a fuzzy logic algorithm. In the sequence “A”, “B”, “C”, “D” and “E”, the proposition that “C is Average” has a truth-value near 1 while the proposition that “C is High” or that “C is Low” has a much lower truth-value. The series “A”, “B”, “C”, “D” and “E” is counted from 0. The value “C” is thus at position 2 and is “Average” to a truth-value of 1. “B”, on the other hand, has a position number of 1 and is “Low” to a truth-value of about 0.9, as well as “Average” to a truth-value of about 0.2. “A” is in position 0 and is thus “Low” to a truth-value of 1.

One method according to one embodiment implicitly assumes a fairly uniform distribution of population members within the alpha sequence. However, in real world situations this is probably optimistic. The process of assigning numeric values to the alphabetic sequence, however, can be easily extended to reflect a more realistic condition set.

For instance, let's assume that the products should be arranged alphabetically by manufacturer on the shelf, but in relation to the manufacturer's percentage of sales. Thus if manufacturer “A” has 17% of the sales, then he should receive roughly 17% of the shelf space. If “B” has 22% of the sales, then he should receive roughly 22% of the space.

What we want is for the products of Manufacturer “A” to fill the horizontal shelf space starting at 0 and extending approximately 17% to the right of that. We want the products of manufacturer “B” to start just to the right of “A's” products and extend to about another 22% of the shelf. And so on.

Accordingly, in one embodiment System 100 operates based at least in part on the following steps:

Computing a set of membership functions based on the length of the shelf with the midpoint at ½ the shelf length.

Computing the physical midpoint of each manufacturer in the set, based on whatever FOM is desired. (for example sales units can be used).

Computing, at a given point along the shelf, the numeric value of the sequence of a given manufacturer based on the physical distance of the point from that manufacturer's specific midpoint.

Thus if we are at a point X on the shelf, looking at a specific product, and we wish to evaluate the proposition “Alpha Sequence is Low”, then the distance of X from that product's manufacturer's midpoint is computed and used as the input to the membership functions computed in step 1, above. The truth-value of the proposition is inversely proportional to the distance computed in step 2.

As an example, for a 100″ shelf, if we are at 8.5″ from the left, then the proposition “AlphaSequence is Low” would evaluate to a truth value of 1. All of the other manufacturers would evaluate to a lower truth value, with manufacturer “E” having the lowest value.

According to one embodiment, these techniques can be used to automate any number of conventional or new business rules for use in an AI Engine. The algorithmic approaches described herein can be coded in any number of computer readable languages, such as C, C++, C#, visual Basic, or the like, and can be stored in any computer readable media, such as magnetic, optic, electronic, and any other form of media for storing or transmitting computer programs.

### Applications and Features

The automated processes and systems described herein enable a much faster, dynamic, and flexible approach to product placement and planogramming generally. For example, the ability to produce store-specific analyses based on FL coded business rules enables the solution of otherwise near-impossible tasks in the retail world. Without having machine-sensible business rules, human beings must necessarily interpret the required business processes introducing significant delay and uncertainty.

Following are several extremely valuable features that provide analyses and procedures that would require massive resources to accomplish with conventional approaches. These features are currently developed in a preferred embodiment of the invention. However, any subset of these features can be provided in alternative embodiments.

### Automatic Adds and Cuts

There is a significant labor cost involved in resetting retail shelves and such changes are not made lightly. Eighty to ninety percent of all changes made to a retail shelf involve the addition and deletion of small numbers of products rather than wholesale readjustments.

In one embodiment, this process is accomplished almost instantaneously and with optimal performance with respect to each individual store based on an automated business-rules approach. In general, to add a single new product to any number of stores, e.g., a subset or all the stores within a chain, the product is added to the central database and the desired planograms are regenerated. The business rules used to make an initial set of planograms are used again to make the same type of optimal decisions in placing the single new product as it did in placing all of the products for the original planograms. The result is an updated set of planograms with the single new product properly placed.

Similarly, to remove a single product from any number of stores, e.g., a subset or all the stores within a chain, that product is simply removed from the central database an new set of planograms are regenerated. The business rules will make the same correct and optimal decisions in generating the updated planograms without the undesired product.

In one embodiment, the add and/or replace features include a phase in/out component. In this embodiment, a series of updated sets of planograms are generated over time taking into account inventory management characteristics. The addition and deletion of products is associated with a date range that accounts for remaining physical stock in the stores, corporate listing and delisting procedures, inventory delivery dates, and the like.

In another embodiment, the add and/or replace features include the ability to minimize their effect in non-proximate portions of the merchandise set. This ability takes into account the cost sensitivity of the product add/remove changes with respect to the store. For example, in one embodiment, the system maintains the ability to prevent the recalculation of existing shelf positions and minimizes the resettlement of products not near the newly added or removed products. The system reads in the prior state of the merchandise set and uses that as a basis to interact with the business rules. For example, an expected addition to the system would understand the labor costs associated with a given product addition or deletion and possibly hold such changes in abeyance until there was a cost-optimal point in time to apply all of the waiting changes.

### Whole Aisle Analysis

Conventionally, retailers merchandise products in aisles grouped by categories of products. Thus, while there is a business related interest in the optimal allocation of products within a single category, there is also a business related interest in the optimal allocation of categories within a single aisle. Further, there is also a business related interest in the optimal allocation of aisles within the entire selling floor spaces, as well as the optimal allocation of back-room storage space. These business-related interests are also capable of being codified as automated computer rules.

Conventional approaches disconnect the aisle analysis from category analysis. One department within a retailer is responsible for the category-within-aisle layout while another department is responsible for the product-within-category layout. These analyses usually occur independently of each other in both time and goal. Specifically, those responsible for the category-within-aisle layout are not attuned to the store-specific contents of those categories. Therefore, the resulting layouts are not optimal.

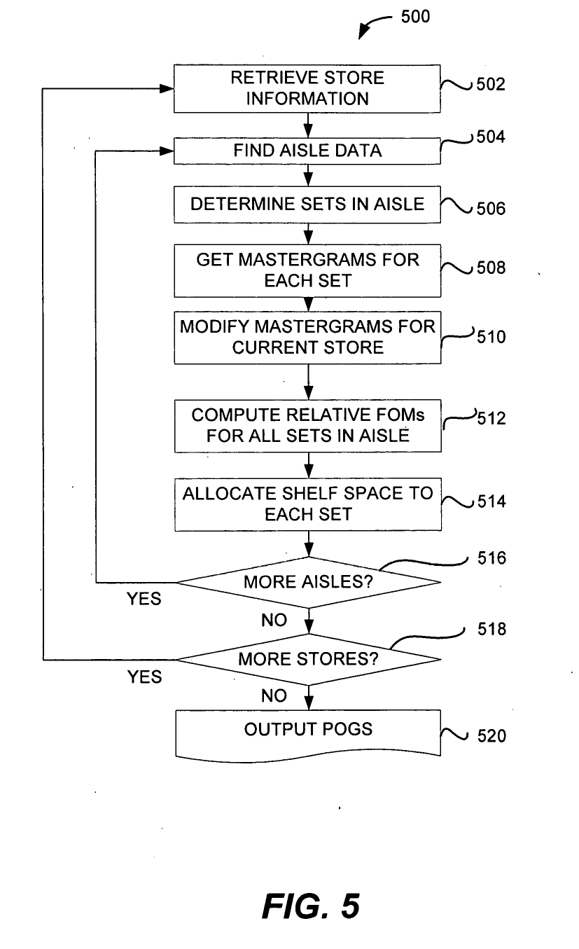

One embodiment uses a set of business rules to optimize both product-within-category and category-within-aisle. For example, the same automated FL business rules are applied to the generation of a supermarket planogram with respect to placement of products in a shelf for a particular category, e.g., canned soups, and to the placement of categories, e.g., canned soups, canned vegetables, and the like, within the shelves in an aisle. As described above, these rules are generally determined based on business concerns, which often derive from consumer research, for example, of buying patterns, visual preferences, and the like. To illustrate this process, in FIG. 5 a flow chart for one embodiment of a category-within-aisle optimization method 500 is shown.

With reference to FIG. 5, in one embodiment, information for processing the first store is retrieved 502. From this information, the data regarding the first aisle is found 504. The sets or categories in that aisle are determined 506 from the aisle data. For example, a category list that had been preset by manual data entry can be included in the store information for that aisle. For each category or set, the applicable Mastergram is retrieved 508. Mastergrams are modified 510 by store-specific data. The Mastergrams are used to compute 512 a relative Figure-of-merit (“FOM”) for all the sets in the aisle. The FOM is representative of a performance marker for the sets, for example, in one embodiment, the FOM is the expected sales volume in cubic units. The product set for an aisle in a store is developed in accordance with the business rules found in the component Mastergram for that aisle, as modified by the characteristics of this particular store. For example, if there are a total of 1000 units expected to be sold in a given aisle in a given store, and each unit occupies 10 cubic inches, the FOM for that entire aisle is 10000. Thus, in this example, an individual set with a FOM of 1500 cubic inches will be assigned 15% of the entire space.

The FOM is used to allocate 514 physical space in the shelving required for each set in the aisle. In one embodiment, the space allocated to a set is approximately the proportion of cubic units for that set in a ratio to cubic units for the whole aisle. In one embodiment, sets are allocated in aisles in units of whole shelf widths with respect to the shelves available in that store (e.g., as provided in the modified Mastergrams). For example, aisles with 4-foot shelves will allocate in even multiples of 4 feet; aisles with 3-foot shelves will allocate in even multiples of 3 feet. Accordingly, in this embodiment, the space allocation process 514 is further refined with the shelving size information, i.e., the initial approximation is rounded to the nearest integral shelf width. Alternatively, in one embodiment, the set allocation is checked to ensure that all sets are allocated at least some space and that the available shelf space in the aisle is optimally utilized. In this embodiment, an algorithm is used to allocate unused space to the better performing sets if an under utilization is determined, and to appropriate space from the lesser performing sets if an over-utilization is determined.

The process is repeated 516 for additional aisles in the selected store. Once all the aisles have been processed, the entire process is repeated 518 for each additional store in a chain, if any. Upon processing all the stores, a set of planograms with the category-within-aisle optimization is output 520.

### Optimal Private Label Analysis

According to another aspect of the present invention, one embodiment includes a private label analysis feature. A private label product is generally one that carries the retailer's own brand name and usually carries a higher profit margin, typically at a lower price, than a nationally branded product of the same configuration or type, generally, the best-selling product of the particular type. As a business practice, the private label products are placed side-by-side with the national brand products in an attempt to capitalize on the brand recognition of the branded products: For this reason, private label products usually have similar package designs to the branded products. Thus, when a consumer looks at the two products side-by-side, she will be “encouraged” to buy the cheaper (but more lucrative) private label item instead of the more expensive branded equivalent.

In order to conform to the business rules driving the private label product placement, traditional allocation methods rely on declaring private label items to have a one-to-one relationship to their top-selling branded counterparts. Thus a fifty-count container of thirteen-gallon private label trash bags would be placed next to the best-selling fifty-count container of thirteen-gallon branded trash bags. However, this traditional allocation method is not the most efficient because the best-selling brand may vary from one store to another. For example, using a conventional graphical input tool in a clustering environment, the traditional process requires placing an image of the private label product next to an image of the best selling branded item for the whole cluster of stores. Thus any store where the best selling branded item is different from the cluster norm will achieve a suboptimal result.

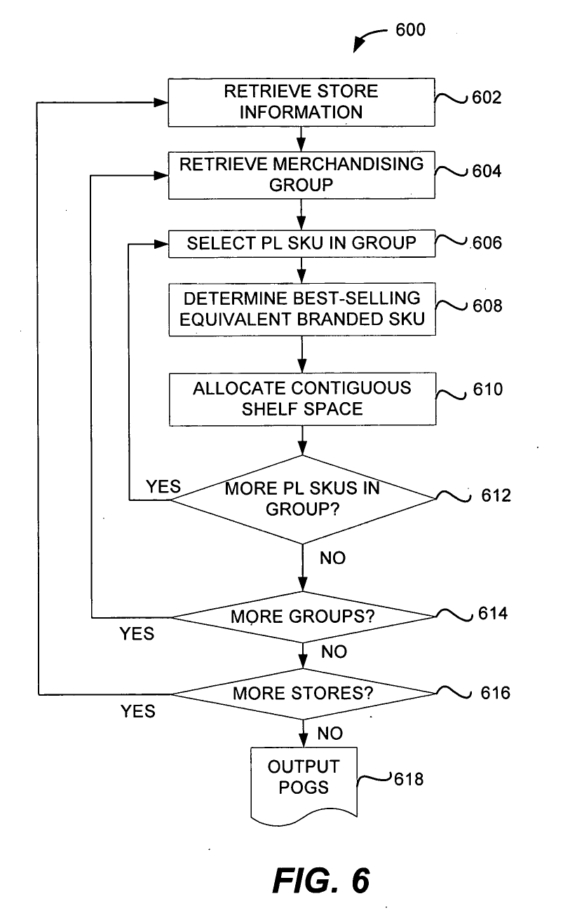

To address this issue, in one embodiment, a private label analysis feature includes a business rule for placing private label products next to the best-selling branded equivalents on a per-store basis. FIG. 6 illustrates this process with a flow chart for one embodiment of a private label analysis method 600.

Referring now to FIG. 6, the store-specific information is retrieved 602. The merchandising groups or categories are retrieved 604. Alternatively, in one embodiment, an analysis is performed to group products together based on the business rules in the business rule engine or otherwise entered by the user. The groups or categories generally involve a “merchandising hierarchy” such as Size within Style within Brand within Segment, typically incorporated in the business rules. A first private label (“PL”) identifier, e.g., a stock keeping unit (“SKU”) number or the like, is selected 606. Then, the best selling equivalent branded product is determined 608. For example, in one embodiment, each product within the merchandising group is assigned a figure-of-merit (“FOM”), e.g., its predicted units of sales. Shelf space is then allocated 610 according to the applicable business rule, e.g., private-label left of equivalent branded product. In the previous example, for that group the PL product with the highest FOM is keyed to the branded product with the highest FOM for placement in contiguous shelf spaces. These products can vary by store. The process is repeated for all the PL products in the merchandising group 612, e.g., PL product with the next highest FOM keyed to branded product with the next highest FOM, and the like. Once all the PL products in the group are allocated, other merchandising groups in a store are processed 614. The process then repeats 616 for all the stores in a chain if applicable. The PL optimized planograms can be output 618 for each store processed.

### Optimal Eye-Level Analysis

Studies have shown that products placed at the eye-level of the average shopper in a store will have better sales. A business rule typically applied to the product placement process is based on this information. Retailers attempt to place their most profitable and/or best-selling items at eye level on their shelves. However, store variation also has a great impact on which are the most profitable and/or best-selling items. Moreover, the height of the average shopper is also a variable, more notably for operations covering a large geographical region. The conventional cluster planogramming approach does not take these local variables into account thus to take them into account would require cumbersome manual modifications.

As described above, in one embodiment the store-specific information can be directly input to the store database and retrieved by the system for planogramming the particular store. Accordingly, the best-selling, and average height values can be defined for any subset of stores or individual stores and used in creating their planograms accordingly. For example, with a business rule such as “Place Best-Sellers at Eye-Level”, a system according to the present invention can make all of these decisions automatically and optimally for each store based on the store specific information.

### Demographic-Specific Layouts

Another feature according to one embodiment includes the ability to vary the shelf layout based on store demographics. For example, for the same category of merchandise, an Asian-affined shelf set can be produced for stores with a large Asian customer base. Similarly, a Hispanic-affined shelf set can be produced for those stores with a large Hispanic customer base. Further, a middle-age/family-of-four affine shelf set can be produced for stores with largely such a customer base. In general, any demographic group whose shelf display preferences can be defined by a set of rules can be used to customize the store layout.

This is accomplished by having the store's customer base appropriately cataloged, as well as having demographic preference factors assigned to each product. The use of the business rule “Match Demographics” feature will then process these factors together in order to optimize the resulting shelf layout. Such demographic groupings can be based on several factor such as age, income, regional location, urbanity, family characteristics, and the like. Moreover, the demographic matching features can be used to find similarities and avoid strong dislikes in the preferences of various groups for combining them for stores with multiple customer bases. For example, a combined shelf set can be defined for a store located between a predominantly Asian and a predominantly Hispanic neighborhoods using preferences in common between the two sets and avoiding strong dislikes in each set of the sets.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention.

1. A computer based merchandising method for generating retail space planograms, the method comprising:
receiving a job data set, the job data set including at least one business rule for associating products with fixture locations;
generating a logic function associated with the business rule based on a description of the business rule;
generating a value for each of a plurality of products with respect to a fixture location based on the logic function;
associating a product with the fixture location by selecting the product from the plurality of products through a comparison of the generated values; and
providing the association of the product with the fixture location.

2. The method of claim 1, wherein generating the logic function comprises applying natural language processing techniques to the description of the business rule.

3. The method of claim 1, wherein the logic function is a fuzzy logic based implementation of the description of the business rule.

4. The method of claim 1, wherein the logic function includes a plurality of associated membership functions mapping numeric attribute values to textual linguistic variables.

5. The method of claim 4, wherein the textual linguistic variables include at least one of the group consisting of high, low, average, good, fair, and poor.

6. The method of claim 1, wherein the job data set further includes store specific data with respect to at least one of store performance markers, store-specific products, store layout, store customer base associated with a store.

7. The method of claim 6, wherein the at least one business rule is based, at least in part, in store specific data of the store.

8. The method of claim 7, wherein the at least one business rule applies to a plurality of products forming a category.

9. The method of claim 8, wherein the at least one business rule is for associating products and categories with fixture locations within an aisle of the store.

10. The method of claim 6, wherein the association of the product with the fixture location based on the store specific data related business rule applies to fixture locations within the store.

11. The method of claim 1, wherein the product is a private label product, and further wherein associating the private label product with the fixture location also includes associating the private label product with a best-selling equivalent national brand product within a merchandising group based on store specific performance marker data.

12. The method of claim 1, wherein the business rule includes product placement preference information associated with one or more demographic groups included in the store's customer base.

13. A computer based merchandising system for generating retail space planograms, the system comprising:
a database for storing a plurality of information components, including a set of store-specific information components; and
a merchandising module coupled to the database module for receiving a description of a business rule and composing an associated logic function for implementing the business rule in generating a planogram.

14. The system of claim 13, wherein the store-specific information includes a set of store-specific business rules.

15. The system of claim 13, further comprising:
a management module coupled to the database for retrieving the planogram and configured to provide an electronic authorization of the planogram.

16. The system of claim 13, further comprising:
a stores module coupled to the database for electronically retrieving the planogram, the stores module including a data interface for providing store-specific information to the database.

17. The system of claim 13, further comprising:
an administration module coupled to the database for providing a data interface to the plurality of information components from retailing computer data systems.

18. The system of claim 13, wherein the logic function includes a set of fuzzy logic membership functions for associating linguistic variables from a textual description of the business rule with numerical values used in generating the planogram.

19. The system of claim 13, the information components include a system dictionary comprising a set of textual phrases for a user to provide the textual description of the business rule, the set of textual phrases associated with logic function blocks configured for automatically composing the associated logic function.

20. The system of claim 13, wherein the merchandising module further comprises an artificial intelligence engine for evaluating the logic function based on data from the information components in the database to generate the planogram.

21. The system of claim 20, wherein the data includes store-specific data from the store-specific information components.

22. A computer readable medium for generating retail space planograms, the computer readable medium comprising program instructions that when executed in a computer system implements the steps of:
receiving a job data set, the job data set including at least one business rule for associating products with fixture locations;
generating a logic function associated with the business rule based on a description of the business rule;
generating a value for each of a plurality of products with respect to a fixture location based on the logic functions;
associating a product with the fixture location by selecting the product from the plurality of products through a comparison of the generated; and
providing the association of the product with the fixture location.

23. A computer based system for generating retail space planograms, the system comprising:
means for receiving a job data set, the job data set including at least one business rule for associating products with fixture locations;
means for generating a logic function associated with the business rule based on a description of the business rule;
means for generating a value for each of a plurality of products with respect to a fixture location based on the logic functions;
means for associating a product with the fixture location by selecting the product from the plurality of products through a comparison of the generated; and
means for providing the association of the product with the fixture location.
